(19) United States
(12) Patent Application Publication
(10) Pub. No.: US 2010/0035093 A1
(43) Pub. Date: Feb. 11, 2010

(54) ULTRACAPACITORS AND METHODS OF MAKING AND USING

(76) Inventors: Rodney S. Ruoff, Austin, TX (US); Meryl Stoller, Austin, TX (US)

Correspondence Address: Ballard Spahr LLP, SUITE 1000, 999 PEACHTREE STREET, ATLANTA, GA, 30309-3915, US

(21) Appl. No.: 12/430,240

(22) Filed: Apr. 27, 2009

Related U.S. Application Data
(60) Provisional application No. 61/048,196, filed on Apr. 27, 2008.

(51) Int. Cl. H01G 9/00; C01B 31/02; H01M 8/00; H01M 4/58

(52) U.S. Cl. 429/12; 361/502; 29/25.03; 423/445 R; 429/231.7

(57) ABSTRACT

An electrochemical device comprising a chemically modified graphene material is disclosed. An ultracapacitor comprising a chemically modified graphene material is disclosed, along either with a method of making an ultracapacitor, the method comprising forming two electrodes, wherein at least one of the two electrodes comprises a graphene material, and positioning each of the two electrodes such that each is in contact with an opposing side of a separator and a current collector

### CROSS REFERENCE TO RELATED APPLICATIONS

This applications claims priority to U.S. Provisional Application Ser. No. 61/048,196, filed Apr. 27, 2008, which is hereby incorporated by reference.

### BACKGROUND

1. Technical Field

The present disclosure relates to graphene materials, and specifically to the use of graphene materials in electrochemical cells or devices.

2. Technical Background

Capacitors are devices that store electrical energy on an electrode surface through the use of an electrochemical cell that creates an electrical charge at the electrode. Ultracapacitors, sometimes referred to as double layer capacitors or electrochemical double layer capacitors, are a type of storage device that creates and stores energy by microscopic charge separation at an electrochemical interface between an electrode and an electrolyte. Ultracapacitors are able to store more energy per weight than traditional capacitors and typically deliver the energy at a higher power rating than many rechargeable batteries. Ultracapacitors typically comprise two porous electrodes that are isolated from electrical contact by a porous separator. The separator and the electrodes can be impregnated with an electrolytic solution, which allows ionic current to flow between the electrodes while preventing electronic current from discharging the cell.

When an electric potential is applied to an ultracapacitor cell, ionic current flows due to the attraction of anions to the positive electrode and cations to the negative electrode. Upon reaching the electrode surface, the ionic charge accumulates to create a charged layer at the solid liquid interface region. This is accomplished by absorption of the charge species and by realignment of dipoles of a solvent molecule. The absorbed charge is held in this region by opposite charges in the solid electrode to generate an electrode potential. This potential increases in a generally linear fashion with the quantity of charge species or ions stored on the electrode surfaces. During discharge, the electrode potential or voltage that exists across the ultracapacitor electrodes causes ionic current to flow as anions are discharged from the surface of the positive electrode and cations are discharged from the surface of the negative electrode while an electric current flows through an external circuit between electrode current collectors.

An ultracapacitor can be used in a wide range of energy storage applications. Some advantages of ultracapacitors over more traditional energy storage devices include high power capability, long life, wide thermal operating ranges, low weight, flexible packaging, and low maintenance. Ultracapacitors can be ideal for any application having a short load cycle, high reliability requirement, such as energy recapture sources including load cranes, forklifts, and electric vehicles. Other applications that can utilize an ultracapacitor's ability to nearly instantaneously absorb and release power include power leveling for electric utilities and factory power backup. A bank of ultracapacitors, for example, can bridge a short gap between a power failure and the startup of backup power generators.

Many capacitors can have a high power density but low energy density which can lead to rapid charge and discharge rates, allowing for a high power supply for only a few seconds. Thus, there is an increasing demand to increase the energy density of ultracapacitors to approach or surpass the energy density of traditional batteries.

Conventional ultracapacitors utilize a high surface area, conductive carbon, such as, for example, activated carbon, sandwiched between a separator and a current collector electrode. In addition to potential cost benefits, other benefits of the compositions and methods of the present disclosure include, the ability to utilize a single carbon material, such as graphene, without the need for supplemental materials.

The existing market for ultracapacitors is estimated to be greater than about $400 million per year. Ultracapacitors developed to date typically have high power density, but lack sufficient energy density to be utilized in many applications. The lack of energy density can result in rapid charge and discharge of the ultracapacitor and can restrict power output to a period of a few seconds. There is a strong interest in increasing the energy density of ultracapacitors to more closely approximate that available for conventional commercial batteries. Thus, there is a need to address the aforementioned problems and other shortcomings associated with traditional ultracapacitors. These needs and other needs are satisfied by the compositions and methods of the present disclosure.

### SUMMARY

In accordance with the purpose(s) of the invention, as embodied and broadly described herein, this disclosure, in one aspect, relates to graphene materials, and specifically to the use of graphene materials in electrochemical cell or devices, such as, for example, ultracapacitors.

In one aspect, the present disclosure provides an electrochemical device comprising a graphene material.

In a second aspect, the present disclosure provides an electrochemical device comprising a chemically modified graphene material.

In a third aspect, the present disclosure provides an ultracapacitor comprising a graphene material and/or a chemically modified graphene material.

In a fourth aspect, the present disclosure provides a method of making an ultracapacitor, the method comprising forming two electrodes, wherein at least one of the two electrodes comprises a graphene material, and positioning each of the two electrodes such that each is in contact with an opposing side of a separator and a current collector.

### BRIEF DESCRIPTION OF THE FIGURES

The accompanying figures, which are incorporated in and constitute a part of this specification, illustrate several aspects and together with the description serve to explain the principles of the invention.

FIG. 1 is a schematic of a conventional electrochemical double layer capacitor.

FIG. 2 is a schematic of a conventional single cell electrochemical double layer capacitor utilizing a separator, activated carbon electrodes, and current collectors.

FIG. 3 is a schematic of a graphene based electrochemical double layer capacitor, in accordance with various aspects of the present disclosure.

FIG. 4 illustrates cyclic voltammetry data obtained from the analysis of a CMG material with (A) potassium hydroxide electrolyte, (B) TEA BF₄ in propylene carbonate, and (C) TEA BF₄ in acetonitrile.

FIG. 5 illustrates Nyquist plots obtained from the analysis of a CMG material with (A) potassium hydroxide electrolyte, (B) TEA BF₄ in propylene carbonate, and (C) TEA BF₄ in acetonitrile

FIG. 6 illustrates equilibrium adsorption isotherms of methylene blue at 30° C. onto graphene oxide in (A) water and (B) reduced graphene oxide in DMF/acetone.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### A. DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a graphene sheet,” “an electrode,” or “an electrolyte” includes mixtures of two or more graphene sheets, electrodes, or electrolytes, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly described above, the present disclosure provides an electrochemical cell or device comprising a graphene material. In various aspects, the graphene material comprises a chemically modified graphene material. In one aspect, the present disclosure provides chemically modified graphene materials (CMG) for the construction of electrodes for ultracapacitors. CMG materials can, in various aspects, impart improved conductivity, resistance to corrosion (e.g., oxidation), and operational lifetimes over conventional carbon and graphene materials, in part, due to the purity and tailored chemical functionality of the material.

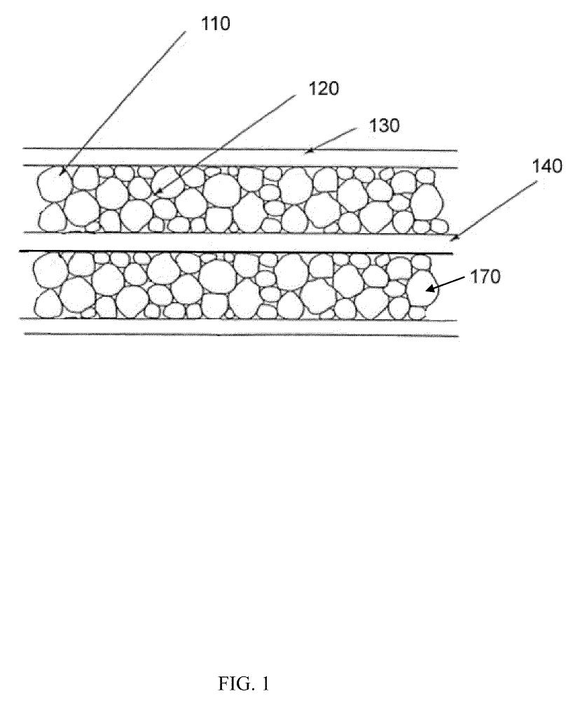

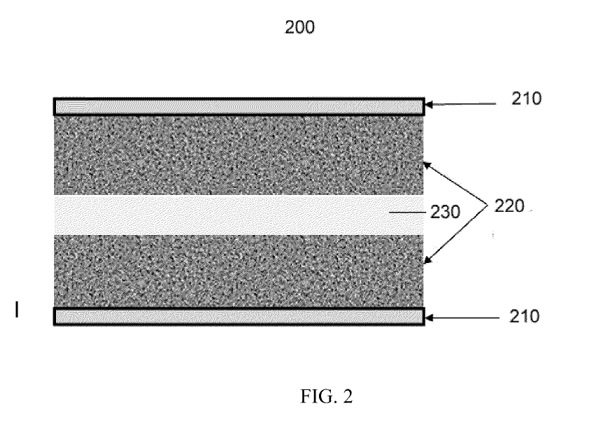

As illustrated in FIGS. 1 & 2, a conventional electrochemical double layer capacitor comprises a current collector 130, 210, a carbon electrode 170, 220, and a separator 140, 230. The electrode of a conventional electrochemical double layer capacitor can comprise high surface area particles 110 each having pores, and electrolyte 120 disposed between the particles. During operation, an electric double layer can accumulate around the particles. In contrast to traditional capacitors, ultracapacitors do not have a conventional dielectric component. Ultracapacitors are based on a structure comprising a thin electrochemical double layer, such as, for example, on the nanometer scale. This double layer thickness, when combined with high surface area carbon materials, can generate high levels of capacitance.

In an electrochemical double layer capacitor, each material layer can be conductive, but the accumulation of charge and interfacial physics present at the surface of each layer effectively means that no significant current can flow between the layers. The high storage density of conventional ultracapacitors can be attributed, in part, to the use of porous materials, such as, for example, activated carbon, for the carbon layer. Activated carbons can have nitrogen surface area values of from about 200 m²/g to about 1,500 m²/g, with most materials having a surface area of about 500 m²/g. While the total nitrogen surface area of activated carbon materials can be relatively high, the porous nature of the activated carbon surface renders much of the available surface area inaccessible to a solvent or electrolyte. In addition, activated carbon materials can often require the addition of supplemental carbon materials, such as carbon black, to improve electrical conductivity.

Graphene and graphene based carbon materials can have significantly larger surface areas than conventional carbon materials used in electrodes. As the capacitance of an ultracapacitor is directly related to the available surface area of the electrode, capacitors having graphene based electrodes can thus exhibit significantly higher capacitance per unit volume and/or unit weight than current ultracapacitor technologies. In addition, the high electrical conductivity of graphene materials can provide a low resistance path for delivery of electrical charge.

Another advantage of the present disclosure is that the graphene and graphene based electrodes of capacitors can be modified to impart compatibility with a range of electrolytes. As the selection of electrolyte in an ultracapacitor can determine the operating voltage limit and energy storage range of the device, the use of a graphene based electrode can provide significantly enhanced energy storage density over ultracapacitors using conventional carbon electrodes.

In various aspects, the present disclosure utilizes a graphene material comprising 1-atom thick sheets of carbon that can optionally be functionalized, for example, with other elements, as needed. The surface area of a single graphene sheet can be markedly higher than other carbon materials, and can be, for example, in the range of about 2,630 m²/g. These graphene materials can thus provide a seven fold increase in available surface area over conventional activated carbons. The physical and chemical versatility of graphene based systems can also provide other advantages when utilized in an electrochemical device as graphene materials do not depend on the distribution of pores in a solid support. Instead, each individual graphene sheet can be capable of moving with respect to other sheets or components to adjust to different electrolytes having various ionic radii, polarity, or other physical properties, while maintaining a high electrical conductivity for the network of individual graphene sheets. Accordingly, each individual graphene sheet can, in various aspects, act as an independent portion of an electrode, responding to local changes in chemical and/or environmental conditions within an electrode structure. This capability can also allow for expansion during operation of a device due to changes in, for example, temperature and/or pressure, and can improve the longevity of the device.

Applications that are ideally suited to the ultracapacitor include any short load cycle, high reliability demand application. Such applications can include energy recapture applications such as, for example, loading cranes, forklifts, and hybrid electric vehicles such as buses, trains, subways, industrial trucks, and passenger cars. These applications can require absorption of braking energy, for example, in the case of a train or bus stopping, or during the lowering of a load, for example, in the case of cranes lowering containers from a ship to the dock. In such cases, the time to absorb (and subsequently release the energy to reverse the action) can be, for example, on the order of seconds to minutes. Using batteries to capture energy for these short time cycles can result in substantial heat generation and yield efficiencies of only about 40 to 50%. For ultracapacitors, yield efficiencies can be greater than about 40%, for example, about 40, 45, 50, 55, 60, 65, 70, 75, 80, 85, or 90%; greater than about 60%, for example, about 60, 65, 70, 75, 80, 85, or 90%; greater than about 80%, for example, about 80, 85, 90, or 95%; or about 90%. Other applications that can utilize an ultracapacitor's ability to almost instantaneously absorb and release power are power leveling for electric utilities and as factory backup power to eliminate spikes and dips in power delivery to automated factories or server farms that require an uninterrupted flow. A bank of ultracapacitors can bridge the short time gap between a power failure and the startup of a backup power generator.

Battery lifetimes and efficiencies can be dramatically shortened when subjected to high pulses of electricity (either when being charged or discharged). Coupling an ultracapacitor with a battery can dramatically lengthen the life of a battery and increase the performance of the energy storage/delivery system. Recent advances in the methodology to couple batteries and ultracapacitors and to balance multiple units together can result in ultracapacitors being applied to a wide range of applications, such as, for example from heavy industrial equipment to light passenger auto applications. Lower energy applications such as hand held power tool and cell phone applications can also benefit from battery/capacitor coupling, yielding longer battery lifetimes and improved power delivery. Other combination and/or hybrid systems for energy storage and/or delivery can also benefit from the compositions and methods of the present disclosure, and any such combinations are intended to be covered by the present disclosure.

Ultracapacitors are replacing batteries in applications that require long lifetimes and high reliability. Any appliance or remote, difficult to service area can be converted to and benefit from an ultracapacitor application. One non-limiting example of such application is the use of ultracapacitors to power the turbine blade pitch system in windmills. Another exemplary application is the use of ultracapacitors to power the start-stop idle off function in hybrid vehicles.

Existing ultracapacitor technology can still, in some circumstances, require the coupling of a battery and an ultracapacitor when long energy durations are needed. The graphene technology of the present disclosure can, in various aspects, provide substantial increases in the storage density of ultracapacitors, such that the need for coupling to a battery can be reduced, and the lifetime and performance of a battery system can be increased. Increased energy storage capability coupled with the high power output and reliability of ultracapacitors prepared in accordance with the various aspects of the present invention can expand current markets and introduce new high volume markets for ultracapacitors, such as, for example, drive-by-wire systems include braking, steering, and shifting.

In addition to improvements in power and storage density, the structure and properties of graphene based materials, such as, for example, chemically modified graphene based materials, can reduce the weight and/or volume of a device comprising the graphene material.

### B. GRAPHENE MATERIAL

Graphene, in various aspects, comprises one-atom thick sheets of carbon. The graphene and graphene based materials of the present invention can optionally be functionalized with other elements. Graphene can be a high surface area material, such as, for example, about 2,630 m²/g for a flat graphene sheet. It should also be appreciated that graphene can be chemically and physically versatile. Rather than depending on the distribution of pores in a solid support, each individual graphene sheet can physically move to adjust as needed, for example, to a varying chemical or environmental conditions, while still maintaining an overall high electrical conductivity for a graphene network.

In one aspect, any graphene is suitable for use with the ultracapacitors and/or other electrochemical devices disclosed herein. In another aspect, a modified graphene, such as, for example, a chemically modified graphene, is suitable for use with the ultracapacitors and/or other electrochemical devices disclosed herein.

In various aspects, the graphene material of the present disclosure can be unmodified, modified, or a combination thereof. In a specific aspect, at least a portion of the graphene material comprises an unmodified graphite material. In another specific aspect, at least a portion of the graphene material comprises a chemically modified graphene material. In yet another aspect, all of or substantially all of the graphene material is chemically modified.

It should be understood that the chemically modified graphene (CMG) material described herein is, in various aspects, fundamentally different than conventional graphene that can be grown by, for example, a chemical vapor deposition process. In one aspect, the CMG material of the present invention can be derived from the chemical treatment of graphite to make graphite oxide, followed by the subsequent exfoliation of graphite oxide in a solvent, such as for example, water. The individual layers of the resulting exfoliated graphite oxide can then be converted, for example, via chemical methods, to CMG that is, in various aspects, electrically conductive, and has a very high surface area and low density. Such properties can allow such a CMG material to have a high specific capacitance and energy density on a per weight basis relative to conventional carbon and graphene materials. Inherent in the preparation methods disclosed herein, the use of graphite as a starting material for CMG materials can also result in low manufacturing costs.

The graphene material of the present invention can be any graphene material suitable for use in an electrochemical device in accordance with the various aspects of the disclosure. In one aspect, the graphene can be produced from thermal expansion of an intercalated graphite. In another aspect, the graphene can be produced by physically disrupting graphite, such as, for example, by ball milling, sonicating, or other suitable techniques. In one aspect, at least a portion of the graphene material can be present or produced in single atomic layer sheets. In another aspect, at least a portion of the graphene material can be present in multilayer sheets, such as, for example, nanoplatelets. In yet another aspect, all or substantially all of the graphene material is present in single atomic layer sheets.

In another aspect, the graphene can be produced via a chemical reaction, such as, for example, by inducing a gas producing chemical reaction within the interlayer structure of a graphite material.

In another aspect, the graphene material can be produced from a graphite oxide material. In a specific aspect, a graphite oxide material can be exfoliated. In one aspect, a graphite oxide can optionally be dispersed in a liquid to form a colloidal suspension. In another aspect, a graphite oxide and/or a colloidal suspension of graphite oxide can be subjected to one or more chemical reaction systems to modify or functionalize the graphite material.

Colloidal suspensions can be of significant importance for industrial scale production of carbon, such as for example, carbon electrodes for ultracapacitors. It is estimated that approximately 4,000 metric tons of carbon are need per year for use in new ultracapacitor systems. With the growing demand for energy storage systems, such as ultracapacitors, this demand could rise to more than 20,000 metric tons of carbon within five years. Production of such volumes using techniques, such as, chemical vapor deposition, can be costly and time consuming. The simplicity of the present invention and the relative abundance of natural graphite thus makes the methods and compositions described herein particularly advantageous.

In another aspect, a graphite oxide can be reduced, for example, in situ, to produce individual graphene sheets. The reduction of any one or more graphite oxide sheets can be performed using any suitable reduction method. In one aspect, the graphite oxide sheets are reduced using hydrazine. Other reduction methods and reducing agents can be utilized and the present disclosure is not restricted to any individual reducing agent. Exemplary reducing agents can comprise iodine, hydroquinone, sodium borohydride, hydrazine, substituted hydrazine, such as, for example, dimethyl hydrazine in DMF, or a combination thereof. Other reducing agents can comprise hydrogen, formaldehyde, hydroxyl amine, primary aliphatic amine, other known reducing agents, or a combination and/or derivative thereof. In another aspect, the graphite oxide sheets can be reduced thermally and can involve methods such as heating in an oven at temperatures ranging from 200 to over 1,000° C. in the presence of gases or while suspended in liquid. The specific parameters, conditions, solvent, if present, and concentrations of a reducing step and/or reducing agent can vary depending upon, for example, the specific materials and intended applications, and the present invention is not intended to be limited to any particular reducing agent or step.

The aspect ratio of any one or more individual graphene sheets produced and/or used in an electrochemical device, such as a capacitor, can vary depending on the particular starting material and method of formation, and the present disclosure is not intended to be limited to any particular aspect ratio. Similarly, the ratio of basal plane area to edge plane area of any one or more graphene sheets can also vary and the present disclosure is not intended to be limited to any particular surface area or ratio of surface areas.

Graphite oxide (GO) can, in one aspect, be produced by methods comprising the steps of exfoliating GO into individual GO sheets followed by in-situ reduction to produce individual graphene-like sheets. Specifically, GO can be produced by the oxidative treatment of graphite using methods known in the art.

Graphite oxide can retain a layered structure, but can be much lighter in color than graphite due to the loss of electronic conjugation brought about by the oxidation. While not wishing to be bound by theory, one hypothesis is that GO comprises oxidized graphene sheets (or ‘graphene oxide sheets’) having their basal planes decorated mostly with epoxide and hydroxyl groups, in addition to carbonyl and carboxyl groups located presumably at edge sites. Such oxygen functionalities can, in various aspects, render the graphene oxide layers of GO hydrophilic, allowing water molecules to readily intercalate into the interlayer galleries. GO can therefore be also thought of as a graphite-type intercalation compound with both covalently bound oxygen and non-covalently bound water between the carbon layers. In one aspect, it should be appreciated that rapid heating of GO can result in expansion and delamination resulting from the rapid evaporation of intercalated water and the evolution of gases produced by thermal pyrolysis of oxygen-containing functional groups.

In one aspect, a graphite oxide can optionally be chemically modified. For example, a highly conductive nanocomposite of polystyrene with uniformly dispersed graphene sheets can be obtained by the reduction of isocyanate-functionalized graphite oxide in the presence of the polymer. In another aspect, transparent and electrically conductive ceramic composites of graphene-based sheets can be produced by exposure of silica sol-gels containing well-dispersed graphene oxide sheets to hydrazine vapor that condensed on the sol-gel surface and accessed the embedded graphene oxide sheets via pores, prior to final curing.

In yet another aspect, a graphite oxide can be modified to enhance one or more physical and/or chemical properties. For example, a paper composed of overlapped and stacked graphene oxide platelets can be cross-linked with one or more alkaline earth metal ions to provide a significant enhancement in mechanical properties.

Graphite oxide materials are typically electrically resistive, due, in part, to the amount of oxygen functional groups present on the surface of the material. In one aspect, a graphene material, after reduction, is electrically conducting, or at least sufficiently electrically conductive to be utilized in an ultracapacitor device.

In one aspect, a CMG material, or a portion thereof, can be functionalized to impart, for example, a desired physical property to the material. In one aspect, at least a portion of the CMG material can be functionalized to control the hydrophilicity of the material. Provided that the CMG material remains sufficiently electrically conductive, any suitable functionalization can be performed. In various aspects, functionalization can comprise the addition of one or more functional groups on at least a portion of the surface of a material. Each of the multiple functional groups, if present, can be the same as or different from any other functional groups. Exemplary functional groups can comprise a carboxyl, quinine, hydroxyl, carbonyl, anhydride, phenol, ether, lactone, nitrogen containing group, sulfur containing group, halide, halogen containing group, or a combination thereof.

In one aspect, the surface chemistry of a graphene material can be tailored to provide, for example, an aqueous dispersable material, a material compatible with other components to be included in a particular electrochemical device, or a combination thereof.

If a particular surface of a graphene material, or a portion thereof, is functionalized, such functionalization can comprise multiple functional groups and can be uniform or can vary across any portion of the surface. In addition, functionalization can be to any extent suitable for use in a particular device. In one aspect, the degree of functionalization can be about up to the level wherein the conductivity of the graphene material is no longer suitable for use in the desire application or device.

### C. ELECTROCHEMICAL DEVICE

The electrochemical device of the present invention can be any device suitable for use with the graphene materials disclosed herein. In various aspects, the electrochemical device can comprise a capacitor, ultracapacitor, fuel cell, battery, or a combination thereof. In one aspect, the electrochemical device is a battery. In another aspect, the electrochemical device is a fuel cell, such as, for example, a polymer electrolyte membrane fuel cell. In a specific aspect, the graphene material can be used as a catalyst support material in a fuel cell electrode. In another specific aspect, the graphene material can be used, for example, as a filler in a polymeric, ceramic, and/or metal matrix.

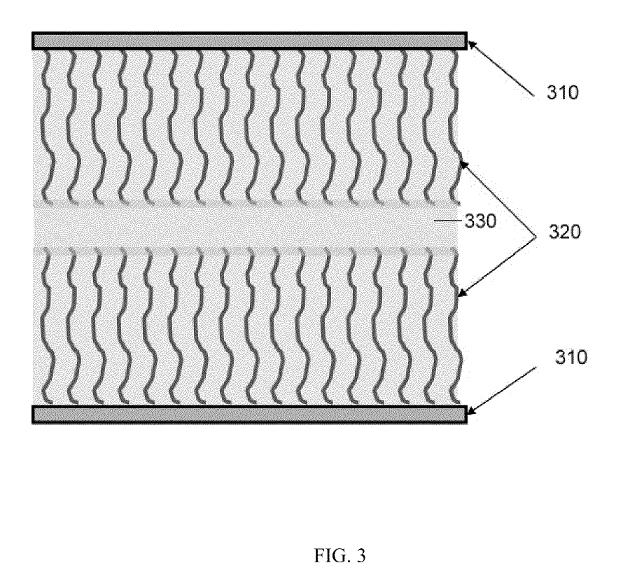

In yet another aspect, a graphene material can be used in a capacitor, such as an ultracapacitor. Ultracapacitors disclosed herein can be used as a component of an electrochemical cell. Ultracapacitors can comprise various components, including one or more cells, electrodes, current collectors, separators, and/or electrolytes. An exemplary device comprises an electrode material (e.g. a carbon material) sandwiched between a current collector (e.g. a metal current collector), and a separator comprising an electrolyte. An exemplary graphene based electrochemical double layer capacitor 300 is illustrated in FIG. 3, comprising current collectors 310, chemically modified graphene electrodes 320, and a separator 330.

In one aspect, the electrochemical device can comprise multiple devices of the same or different type, such as, for example, a hybrid power system. Any suitable combination of an ultracapacitor, battery, fuel cell, or other power generation, storage, or management device is intended to be covered by the present disclosure.

The specific capacitance of a graphene material used in an ultracapacitor can, in various aspects, exceed that otherwise attainable with conventional carbon based ultracapacitors. Such capacitance values for the graphene material can be about 100 F/g or more, for example, about 100, 150, 200, 250, 275, 300, 325, 350, 400, 500, 600, 700, 800 F/g, or more; about 500 F/g or more, for example, about 500, 550, 600, 650, 700, 750, 800 F/g or more; or about 800 F/g or more, for example, about 800, 825, 850, 875, 900, 1,000 F/g or more. Similarly, the energy density of a graphene based ultracapacitor can, in various aspects, exceed that attainable with conventional ultracapacitors. Such energy density values can be greater than about 4 Wh/kg, for example, about 4.5, 5, 5.5, 6, 7, 8, 9, 10, 12, 14, 16, 18, 20, 22, 25, 28, 30, 35, 40, 45, 50, 55, 60, 65, 70, 75 Wh/kg or more; greater than about 10 Wh/kg, for example, about 10, 12, 14, 16, 18, 20, 22, 25, 28, 30, 35, 40, 45, 50, 55, 60, 65, 70, 75 Wh/kg or more; or greater than about 25 Wh/kg, for example, about 25, 28, 30, 35, 40, 45, 50, 55, 60, 65, 70, 75 Wh/kg or more. In another aspect, the energy density of a graphene based ultracapacitor can be at least about 25% greater than that of conventional ultracapacitors, for example, about 25, 30, 35, 40, 45, 50, 60, 70, 80, 90, 100, 200, 300, 500% or greater than that of conventional ultracapacitors.

1. Electrode

An electrode for the electrochemical device can be any electrode suitable for use in the device and that utilizes the graphene material disclosed herein. In one aspect, an electrode comprises one or more electrodes of a battery. In another aspect, an electrode comprises one or more individual electrodes of a fuel cell, such as a polymer electrolyte membrane fuel cell. In yet another aspect, an electrode comprises one or more individual electrodes in or suitable for use in an ultracapacitor.

In one aspect, an individual electrode can comprise one or more individual graphene sheets. In another aspect, an electrode can comprise a single graphene sheet, such as, for example, in a nanoelectronic device. In another aspect, an electrode can comprise a plurality, for example, about 2, 5, 10, 20, 200, 500, or more individual graphene sheets. In various aspects, each of a plurality of individual graphene sheets, if present, can be arranged in any suitable manner for the intended device and application. In one aspect, one or more of the graphene sheets are oriented perpendicular to a separator, such that at least a portion of the edge plane of the graphene material is in contact with at least a portion of the separator, a current collector, or a combination thereof. In another aspect, one or more of the graphene sheets are randomly oriented within the electrode structure. In yet another aspect, the orientation of one or more graphene sheets varies such that at least a portion of the graphene sheets are oriented perpendicular to the separator and at least a portion are randomly oriented. Other orientations and combinations of orientations of any one or more individual graphene sheets are possible and the present invention is not intended to be limited to any particular orientation or arrangement of graphene material.

In one aspect, at least a portion of the graphene sheets are positioned sufficiently close to each other to provide a percolation pathway for conduction through the electrode layer.

In another aspect, an electrode or a portion thereof should be capable of being at least partially wetted by an electrolyte solution so as to provide access to all or substantially all of the surface area of the graphene material. In yet another aspect, all or substantially all, of the surface of the graphene material comprising the electrode is wettable by an electrolyte.

The electrode of an electrochemical device can optionally comprise additional components, such as, for example, other carbon materials, binders, ionic liquids, ionically conducting polymers, or a combination thereof. In one aspect, an electrode comprises a graphene material and at least one additional carbon material, such as, for example, activated carbon, graphite, carbon black, carbon nanotubes, fullerenes, metal nanoparticles, polymers, or combinations thereof. In another aspect, an electrode can comprise Nafion (poly-perfluorosulfonic acid). In yet another aspect, an electrode comprises or substantially comprises a graphene and/or graphite oxide based paper material.

A specific electrode composition disclosed herein comprises a PTFE or Teflon binder (e.g., 3% PTFE/Teflon binder) and can optionally include other materials, such as, for example, graphite.

Also contemplated for use with the disclosed ultracapacitors is ‘graphene oxide paper’, a free-standing carbon based membrane material made by flow-directed assembly of individual graphene oxide sheets (also called platelets). Graphene oxide paper can be made, for example, through vacuum filtration of colloidal dispersions of graphene oxide sheets through an ANODISC® membrane filter, followed by drying. This method can produce free-standing graphene oxide paper with thicknesses ranging from about 1 to about 30 microns. A graphene oxide paper material, if formed into a ‘paper-like material’, can be reduced prior to, during, or after formation into the paper-like material. Another form can include graphene material supported within a polymer, gel, or nanoparticle matrix. This matrix can maintain separation of the graphene material to allow greater access of the surface area.

2. Electrode Substrate

An electrode in an ultracapacitor can be in proximity to or in contact with a substrate, such as, for example, a current collector. An electrode material (e.g. a carbon material) can be deposited onto a current collector using methods known in the art. Any suitable known coating or deposition method can be used, such as doctor blade coating or air knife coating, electrophoresis, casting, among others. In one aspect, an electrode or at least a portion thereof can be in electrical communication with a current collector.

Any current collector suitable for use in an electrochemical device, such as an electrochemical double-layer capacitors can be selected for use as the current collector in the positive and negative electrodes. The current collectors of an electrochemical device, such as, for example, an ultracapacitor, can comprise, in various aspects, aluminum, copper, nickel, or a combination thereof. In other aspects, a current collector can comprise a material that can be plated or coated with, for example, aluminum, copper, nickel, or a combination thereof. Each of the current collectors can comprise the same or a different material than any other current collector. Other current collector compositions can also be utilized and the present disclosure is not intended to be limited to any particular current collector or current collector composition.

A non-limiting example of an electrode substrate comprises a PVC film, with optional loading of carbon black, such that the material can conduct electrons to and from the electrode layer. The materials, such as, for example, foils, making up the respective current collectors can be in any of various forms, including thin foils, flat sheets, and perforated, stampable sheets, etc. The foil can have any suitable thickness, taking into account, for example, the density of the activated carbon over the entire electrode and the strength of the electrode. Polarizable electrodes can also be fabricated by melting and blending the polarizable electrode composition, then extruding the blend as a film.

Optionally, additional conductive material can be added to the above-described electrode materials, if desired. The conductive material can be any suitable material capable of conferring electrical conductivity to the electrode material. Illustrative, non-limiting, examples include carbon black, Ketjenblack, acetylene black, carbon whiskers, carbon fibers, carbon nanotubes, fullerenes, natural graphite, artificial graphite, other carbon nanomaterials, titanium oxide, ruthenium oxide, and metallic fibers such as aluminum or nickel fibers. Any one or combinations of two or more thereof can be used.

3. Separator

An ultracapacitor or other electrochemical device can also comprise a separator. A separator can be one that is commonly used in electrochemical double layer capacitors. Illustrative examples include polyolefin nonwoven fabric, polytetrafluoroethylene porous film, kraft paper, sheet laid from a blend of rayon fibers and sisal hemp fibers, manila hemp sheet, glass fiber sheet, cellulose-based electrolytic paper, paper made from rayon fibers, paper made from a blend of cellulose and glass fibers, and combinations thereof in the form of multilayer sheets. For example, Celgard 3501 polypropylene can be used as a separator material. Separator materials are commercially available and one of skill in the art could readily select an appropriate separator or separator material. The present disclosure is not intended to be limited to any particular separator material.

4. Electrolyte

Any electrolyte material that can provide a charge reservoir for an ultracapacitor is contemplated for use with the ultracapacitors disclosed herein. The electrolyte can be a solid or fluid. In general, an electrolyte material can be chosen so as to minimize internal resistance of an ultracapacitor. Fluid electrolytes in ultracapacitors can be aqueous, organic, or ionic, or a combination thereof.

Any aqueous electrolyte compatible with the ultracapacitors disclosed herein can be used. Non-limiting examples include H₂SO₄, KOH (e.g., 6 M KOH), KF, NaOH, or a combination thereof.

Organic electrolytes are also contemplated for use with the ultracapacitors disclosed herein. Phosphonium and ammonium salts are non-limiting examples of organic electrolytes. Non-aqueous, dipolar aprotic solvents with high dielectric constants, such as organic carbonates and/or acetonitrile (AN), can also be used. Examples of suitable organic carbonates include ethylene carbonate (EC), propylene carbonate (PC), propanediol-1,2-carbonate (PDC), and dichloroethylene carbonate (DEC). In one aspect, the ability to chemically modify a CMG sheet can provide the ability to utilize virtually any electrolyte or combination of electrolytes. For example, the ability to tailor the hydrophilicity and chemical compatibility of the graphene material with the electrolyte can be advantageous over conventional carbon and electrode materials and conventional ultracapacitor designs.

Other examples of organic electrolytes include polymer gel electrolytes. Polymer gel electrolytes are polymer-electrolyte systems, in which the polymer forms a matrix for the electrolyte species. A plasticizer can also be a component of the polymer-electrolyte system. Examples of suitable polymer gel electrolytes include, but are not limited to, such systems as polyurethane-LiCF₃SO₃, polyurethane-lithium perchlorate, polyvinylacohol-KOH—H₂O, poly(acrylonitrile)-lithium salts, poly(acrylonitrile)-quaternary ammonium salts, and poly(ethylene oxide)-grafted poly(methyl)-methacrylate-quaternary ammonium salts. Additionally, other compounds, such as ethylene carbonate and propylene carbonate, can also be incorporated into the polymer matrix.

Ionic liquids are also suitable for use with the ultracapacitors disclosed herein. Suitable ionic liquids can include, in various aspects, one or more cationic salts. Non-limiting examples include imidazolium, pyrrolidinium, tetraalkylammonium, pyridinium, piperidinium, and sulfonium based ionic liquids.

Any anion can be combined with a cation of an ionic liquid, keeping in mind that the van der Waals volumes can affect electrolytic performance. Non-limiting examples include BF₄⁻, PF₆⁻, AsF₆⁻, ClO₄⁻, CF₃SO₃⁻, AlCl₄⁻, and SbF₆⁻, among others. In one aspect, an electrolyte can comprise tetramethylammonium tetrafluoroborate (TEMA-BF₄) at a suitable concentration, e.g., about 1 M, or about 1.8 M. TEMA-BF₄ can be in a solution of an appropriate solvent (e.g., propylene carbonate). In another aspect, an electrolyte can comprise tetraethylammonium tetrafluoroborate (TEA-BF₄) at a suitable concentration, for example, about 1 M TEA-BF₄ in a solution of a suitable solvent, such as acetonitrile.

The liquid electrolyte used in the present invention can be a salt comprising a combination of the above-described cations and anions. A selection can be made to have an electrolyte which has a wide potential window, low viscosity, high ion conductivity, is liquid over a wide range of temperatures, and is stable, if these properties are desirable for a particular application.

Since liquid electrolytes are liquid at room temperature, they can, in various aspects, be used intact as electrolyte solutions (so-called neat electrolyte solutions). In a case of an electrolyte that has a high melting point and is solid at room temperature, it can, in one aspect, be dissolved in an organic solvent, so that the electrolyte can be used as an electrolyte solution. In another aspect, an electrolyte that is a liquid at room temperature can be dissolved in an organic solvent and used.

### D. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. General Methods

In a first example, graphite oxide was prepared from purified natural graphite (SP-1, 30-lm nominal particle size, Bay Carbon, Bay City, Mich.) by the Hummers method [Hummers W, Offeman R. “Preparation of graphitic oxide.” J. Am. Chem. Soc 1958; 80:1339].

Characterization of graphite oxide was performed using methods known in the art, including SEM, AFM, XPS, TGA, NMR, and IR. SEM images were obtained with a field emission gun scanning electron microscope (LEO1525, Carl Zeiss SMT AG, Oberkochen, Germany). Samples for AFM imaging were prepared by depositing colloidal suspensions of GO on freshly cleaved mica surfaces (Ted Pella Inc., Redding, Calif.). AFM images were taken on a MultiTask AutoProbe CP/MT Scanning Probe Microscope (Veeco Instruments, Woodbury, N.Y.). Imaging was done in non-contact mode using a V-shape “Ultralever” probe B (B-doped Si with frequency fc=78.6 kHz, spring constants k=2.0-3.8 N/m, and nominal tip radius r=10 nm, Park Scientific Instruments, Woodbury, N.Y.). All images were collected under ambient conditions atm 50% relative humidity and 23° C. with a scanning raster rate of 1 Hz. Surface area analysis was performed with a Micromeritics ASAP 2010 Analyzer (Micromeritics Instrument Corporation, Norcross, Ga.). The samples were outgassed at 3 mTorr and 150° C. for 24 h prior to analysis. Elemental analyses and Karl-Fisher titration were performed by Galbraith Laboratories (Knoxville, Tenn.). XPS measurements were performed using an Omicron ESCA Probe (Omicron Nanotechnology, Taunusstein, Germany) with a monochromated Al Ka radiation (hm=1486.6 eV). TGA was performed under a nitrogen flow (100 mL/min) using a TA Instruments TGA-SDT 2960 on sample sizes from 5 to 6 mg, and the mass was recorded as a function of temperature. The samples were heated from room temperature to 800° C. at 5° C./min. To avoid thermal expansion of the GO due to rapid heating, GO samples were also heated from room temperature to 800° C. at 1° C./min. Solid-state FT-NMR spectra were recorded on a Chemagnetic CMX 400 instrument equipped with a 4-mm magic angle spinning (MAS) probe at a magnetic field of 9.4 T. The neat samples (28 mg each) were spun at 9.4 kHz to average the anisotropic chemical shift tensor. Spectra based on free induction decays with moderate decoupling power were averaged over 18,000 scans with a recycle delay of 8 s. The 90° pulse is 2.5 ls as determined by acquisition on adamantane. Solid adamantane (38.3 ppm) was also used as the external reference for ¹³C chemical shift based on the TMS scale. Raman spectra were recorded from 200 to 2000 cm⁻¹ on a Renishaw 2000 Confocal Raman Microprobe (Rhenishaw Instruments, England) using a 514.5-nm argon ion laser.

2. Exfoliation of Graphite Oxide (GO) in Water

In a second example, a sample of graphite oxide was exfoliated in water. One property of GO, brought about by the hydrophilic nature of the oxygenated graphite layers, is its easy exfoliation in aqueous media. As a result, GO readily forms stable colloidal suspensions of thin ‘graphene oxide’ sheets in water. After a suitable ultrasonic treatment, such exfoliation can produce stable dispersions of very thin graphene oxide sheets in water. These sheets are, however, different from graphitic nanoplatelets or pristine graphene sheets due to their low electrical conductivity. However, it should be appreciated that sufficiently dilute colloidal suspensions of GO prepared with the aid of ultrasound are clear, homogenous, and stable indefinitely. AFM images of GO exfoliated by the ultrasonic treatment at concentrations of 1 mg/mL in water always revealed the presence of sheets with uniform thickness (about 1 nm). These well-exfoliated samples of GO contained no sheets either thicker or thinner than 1 nm, leading to a conclusion that complete exfoliation of GO down to individual layers of graphite oxide (thus termed ‘graphene oxide sheets’) was indeed achieved under these conditions. While a pristine graphene sheet is atomically flat with a well-known van der Waals thickness of about 0.34 nm, graphite oxide sheets are expected to be ‘thicker’ due to the presence of covalently bound oxygen and the displacement of the sp³-hybridized carbon atoms slightly above and below the original graphene plane. From XRD experiments, the intersheet distance for GO varies with the amount of absorbed water, with values such as 0.63 nm and 0.61 nm reported for “dry” GO samples (complete drying of GO is probably impossible) to 1.2 nm for hydrated GO. If these values could be regarded as the “thickness” of a hydrated individual GO layer, given the uniformity of the observed thicknesses in our GO materials and that sheets one-half (or any other inverse integer value, such as one third, etc.) of the minimum thickness obtained by AFM are never observed, the GO sheets observed by AFM represent fully exfoliated, individual layers of graphite oxide. (Noteworthy is that heights significantly smaller than 1 nm are observable in our AFM experiment; an example of which is the observation of C₁₂ amine adsorbed onto freshly cleaved mica from the vapor phase. This makes the mica hydrophobic in just a few minutes and when a new clean AFM tip is brought into contact with the monolayer, some of the C₁₂ amine wicks up the tip and depletes the monolayer. The resulting voids left in the film are around 0.2 nm deep. Thus, if platelets (also called “sheets”) with thicknesses that are less than those observed for the exfoliated GO samples discussed herein were present, they would be readily detected.

3. Reduction of Exfoliated Graphite Oxide (GO)

In a third example, graphite oxide (GO) (100 mg) was loaded in a 250-mL roundbottom flask and water (100 mL) was then added, yielding an inhomogeneous yellow-brown dispersion. This dispersion was sonicated using a Fisher Scientific FS60 ultrasonic bath cleaner (150 W) until it became clear with no visible particulate matter. Hydrazine hydrate (1.00 mL, 32.1 mmol) was then added and the solution heated in an oil bath at 100° C. under a water-cooled condenser for 24 h over which the reduced individual layers of graphite oxide (i.e., ‘graphene oxide sheets’) gradually precipitated out as a black solid. This product was isolated by filtration over a medium fritted glass funnel, washed copiously with water (5×100 mL) and methanol (5×100 mL), and dried on the funnel under a continuous air flow through the solid product cake.

4. Preparation of Graphene Oxide Paper

In a fourth example, graphite oxide was synthesized from purified natural graphite (SP-1, Bay Carbon) by the Hummers method. Colloidal dispersions of individual graphite oxide sheets in water at the concentration of 3 mg/mL were prepared with the aid of ultrasound (Fisher Scientific FS60 ultrasonic cleaning bath) in 20 mL batches. ‘Graphene oxide paper’ was made by filtration of the resulting colloid through an Anodisc membrane filter (47 mm in diameter, 0.2 mm pore size; Whatman), followed by air drying and peeling from the filter. The thickness of each graphene oxide paper sample was controlled by adjusting the volume of the colloidal suspension. Samples of graphene oxide paper prepared in this manner were cut by a razor blade into rectangular strips for testing without further modification.

The thermal stability of graphene oxide paper was characterized by thermogravimetric analysis (TGA-SDT 2960, TA Instruments). All measurements were conducted under dynamic nitrogen flow (industrial grade, flow rate 100 ml/min 21) over a temperature range of 35-800° C. with a slow ramp rate of 1° C./min to prevent sample loss. Static mechanical uniaxial in-plane tensile tests were conducted with a dynamic mechanical analyser (2980 DMA, TA Instruments). The samples were gripped using film tension clamps with a clamp compliance of about 0.2 μm/N. All tensile tests were conducted in controlled force mode with a preload of 0.01 N and a force ramp rate of 0.02 N/min. The sample width was measured using standard calipers (Mitutoyo). The length between the clamps was measured by the DMA instrument, and the sample thickness was obtained from SEM imaging of the fracture edge.

5. Sample Preparation and Measurement of Electrical Conductivity

In a fifth example, the electrical conductivity of powders of dried down reduced graphene oxide platelets was measured at different apparent densities (created by compressing the samples to varying degrees). A given quantity of powder was poured into a glass tube (ID=5 mm) and manually compressed between two copper plungers that fit closely to the tube ID. A DC power supply (Agilent 6613C, Agilent Technologies, Santa Clara, Calif.), picoampere meter (Keithley 6485, Keithley Instruments, Cleveland, Ohio), and multimeter (HP 34401A, Hewlett-Packard, CA) were connected to measure DC conductivity by a two-probe method.

A digital micrometer (Mitutoyo Corporation, Kanagawa, Japan) was used to measure the height of the powder column at each compression step. In the present work, values for electrical conductivity for pristine graphite, GO, and reduced and agglomerated graphene oxide platelets, were determined by fitting the experimental data to the equation: σ_{c}=σₕ[(φ−φ_{c})/(1−φ_{c})]^{k}, derived from the general effective media (GEM) equation [McLachlan D S. “Equations for the conductivity of macroscopic mixtures.” J Phys C: Solid State Phys 1986; 19(9):1339-54; McLachlan D S. “An equation for the conductivity of binary mixtures with anisotropic grain structures.” J Phys C: Solid State Phys 1987; 20(7):865-77] with an assumption that the conductivity of the low-conductive phase (air) is zero. In this expression σ_{c} is the conductivity of the composite medium, σₕ and φ are the conductivity of the highly-conductive phase and their volume fraction, respectively, φ_{c} is the percolation threshold, and k is a critical exponent related to the percolation threshold and to the shape of the particles. This formula has identical form as in the geometrical percolation model (GPM) [Kirkpatrick S. “Percolation and conduction.” Rev Mod Phys 1973; 45:574-88], with the exception of the critical exponent, k, which can have values different from the universal value of 2 as determined for the 3-dimensional GPM. The two fitting parameters in the GEM equation are rh and k. The percolation threshold, φ_{c}, is determined as a ratio of the apparent powder density before compression, dₚ, and the apparent density of the particles, d_{g}. The bulk density of graphite (2200 kg/m³) has been used in all cases as a value for d_{g}. This assumption has been proven to be correct within an accuracy of 5% by measuring the apparent density of powder samples that were compressed at a pressure of 300 MPa.

6. Specific Capacitance of Graphene Material and Energy Density of Electrochemical Double Layer Capacitors

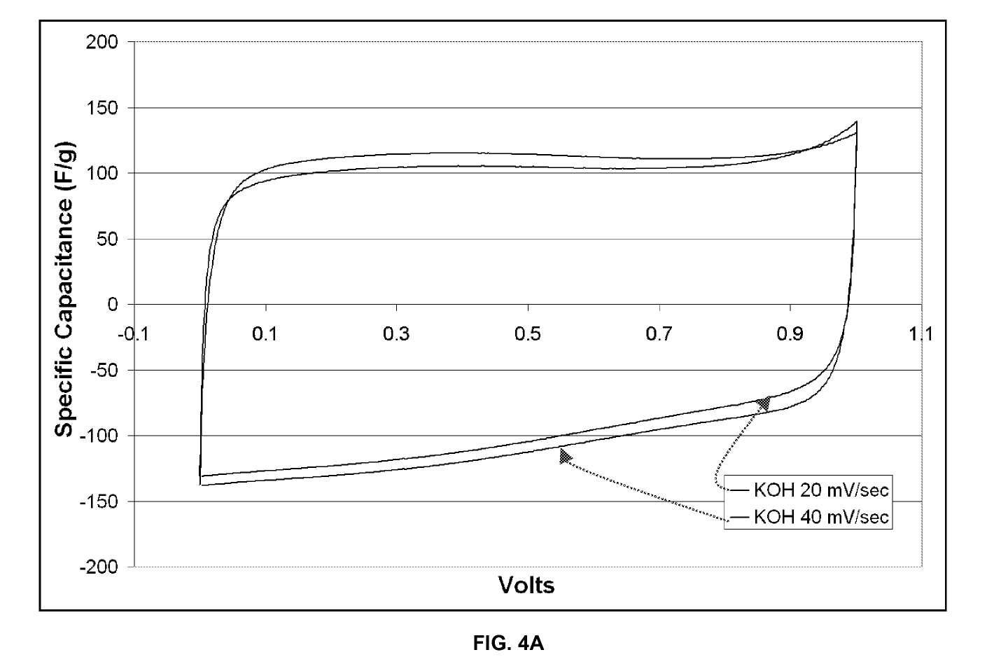

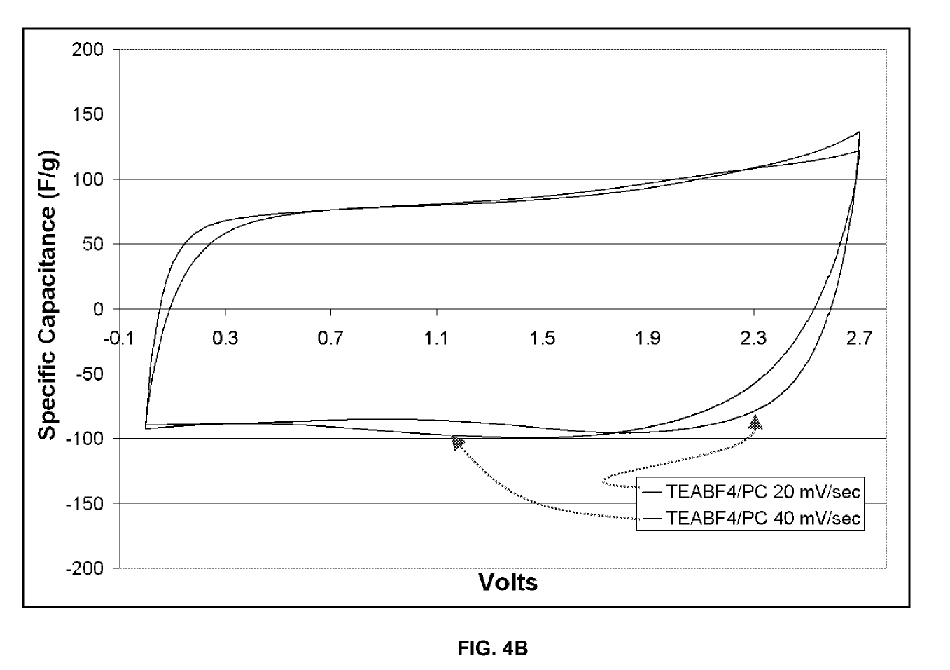

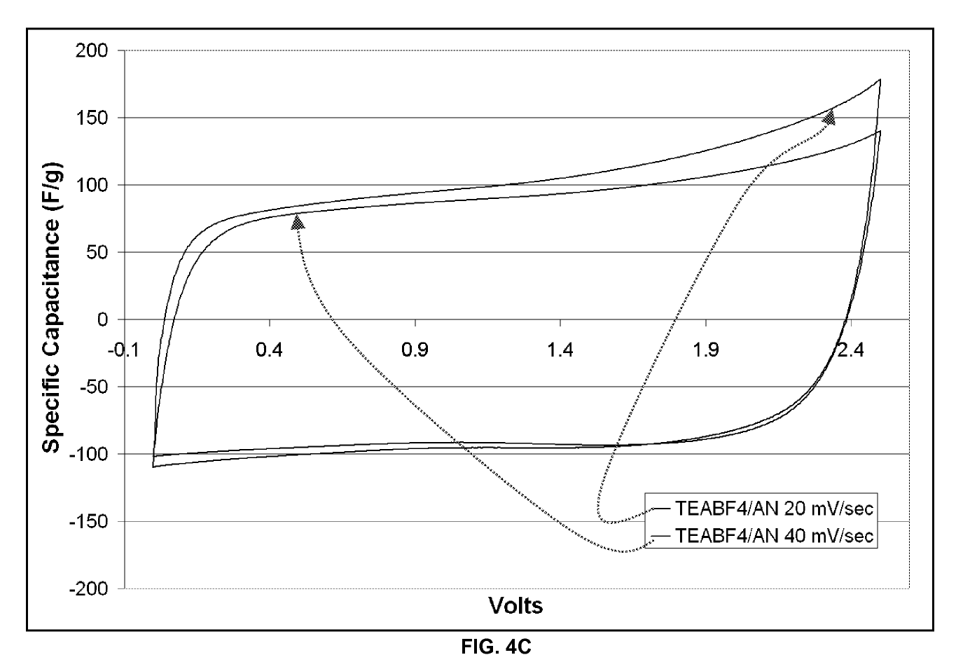

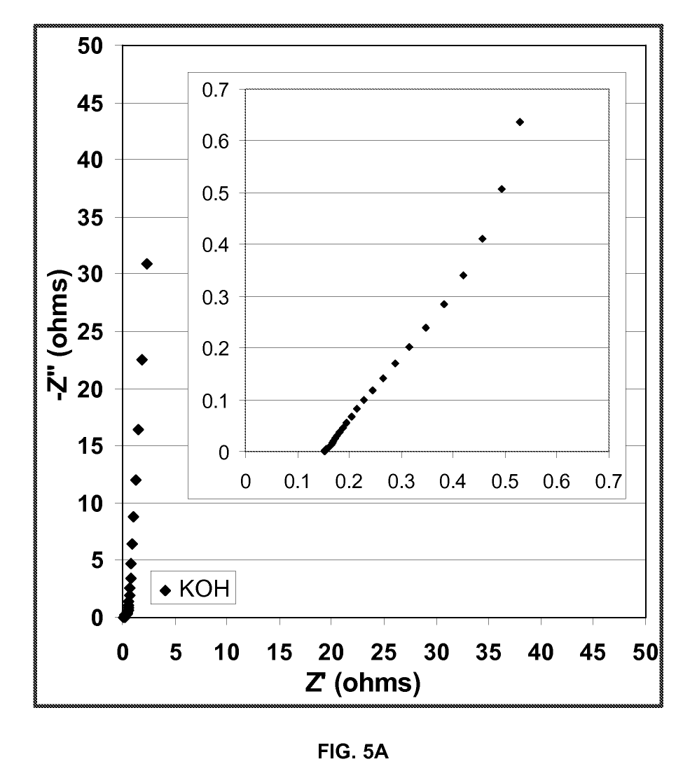

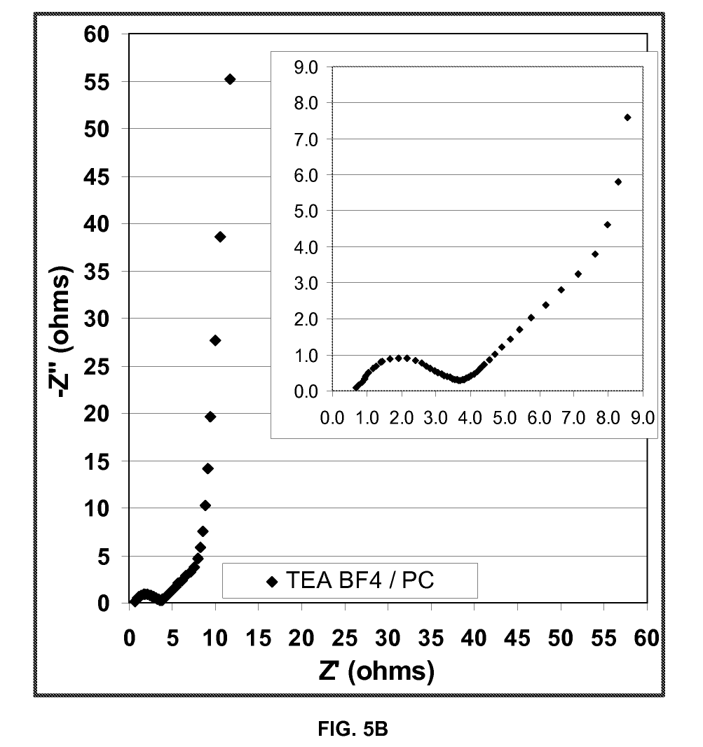

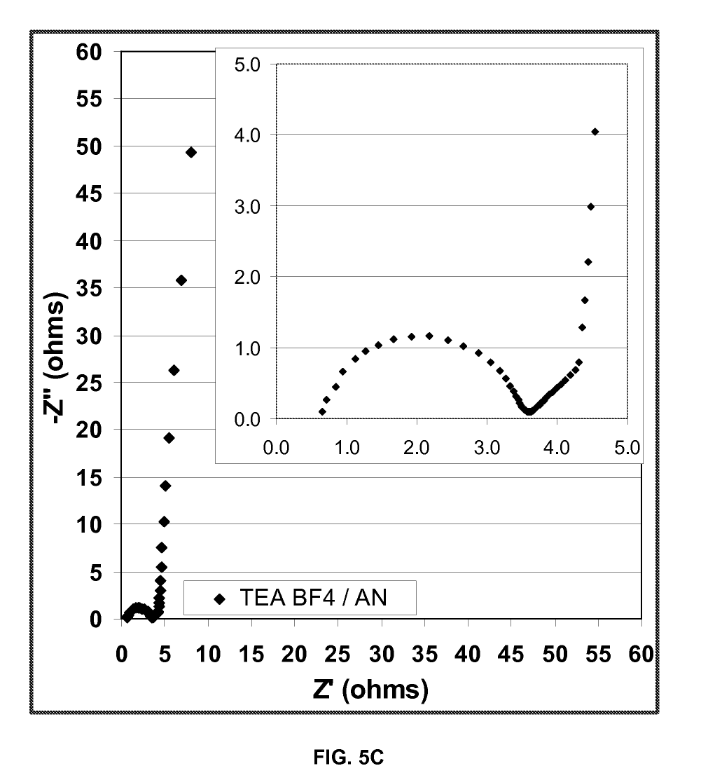

In a sixth example, particles comprising agglomerated graphene sheets were assembled into electrodes by mixing with 3% by weight polytetrafluoroethylene binder (PTFE 60% dispersion in H₂O, Sigma Aldrich). The mixture was homogenized in an agate mortar, formed into electrodes by rolling the CMG/PTFE mixture into 75-micron thick sheets, and finally by punching out 1.6-cm diameter discs. The nominal weight of an electrode was 0.0075 grams. The two electrode test cell assembly is made of two current collectors, two electrodes, and a porous separator (Celgard 3501). The collector material was from Intelicoat Technologies—a 4 mil conductive vinyl film was used with the aqueous electrolyte and a 0.5 mil aluminum foil with conducting carbon coating was used with the organic electrolytes. The cell assembly was supported in a test fixture consisting of two stainless steel plates fastened together using threaded bolts. Spacers (PET, McMaster Carr) were placed between the SS plates to electrically isolate the plates, provide a hermetic seal, and maintain a consistent, even pressure on the cell. Aqueous electrolyte was 5.5 M KOH (Fisher). Organic electrolytes were prepared using 1 M Tetraethylammonium tetrafluoroborate (TEA BF₄, electrochemical grade>99%, Sigma Aldrich) in acetonitrile (“AN”, anhydrous, 99.8%, Sigma Aldrich) or in propylene carbonate (“PC”, anhydrous, 99.7%, Sigma Aldrich). CV curves (FIG. 4), electrical impedance spectroscopy (EIS) (FIG. 5), and galvanostatic charge/discharge testing was done with an Eco Chemie Autolab PGSTAT100 potentiostat equipped with the FRA2 frequency response analyzer module and GPES/FRA software. CV curves were scanned at voltage ramp rates of 20 and 40 mV per second. EIS was done using a sinusoidal signal with mean voltage of 0 V and amplitude of 10 mV over a frequency range of 500,000 Hz to 0.01 Hz. Capacitance values were calculated for the CV curves by dividing the current by the voltage scan rate, C=I/(dV/dt). Specific capacitance, as detailed in Tables 1 and 2 below, is the capacitance for the carbon material of one electrode (Specific Capacitance=capacitance of single electrode/weight CMG material of single electrode), as per the normal convention. Galvanostatic charge/discharge was done at constant currents of 10 and 20 mA. Capacitance as determined from galvanostatic charge/discharge was measured using C=I/(dV/dt) with dV/dt calculated from the slope of the discharge curves.

TABLE 1
Specific Capacitance (F/g) of CMG material
in KOH electrolyte by scan rate (mv/sec).

| scan rate | CV average specific |
|---|---|
| (mV/sec) | capacitance (F/g) |
| 20 | 101 |
| 40 | 106 |
| 100 | 102 |
| 200 | 101 |
| 300 | 96 |
| 400 | 97 |

TABLE 2
Specific Capacitance (F/g) of CMG material.

| | |
|---|---|
| galvanostatic | cyclic voltammogram |
| discharge (mA) | average (mV/sec) |

| electrolyte | 10 | 20 | 20 | 40 |
|---|---|---|---|---|
| KOH | 135 | 128 | 100 | 107 |
| TEABF₄/PC | 94 | 91 | 82 | 80 |
| TEABF₄/AN | 99 | 95 | 99 | 85 |

In a another example, a variety of electrochemical double layer capacitor designs were modeled to determine, inter alia, the specific capacitance and energy density thereof. The specific capacitance of the graphene material for a single cell graphene based ultracapacitor was estimated to be about 500 F/g, and 600 F/g for an at least partially optimized version thereof. Similarly, the energy densities for the single cell CMG based ultracapacitor and an optimized version thereof were determined to be 30 Wh/kg and 34 Wh/kg, respectively. It should be understood that the experimentally observed specific capacitance values can vary depending on, for example, the cyclic voltammetric scan rate of the experiment.

7. Specific Surface Area Using Methylene Blue

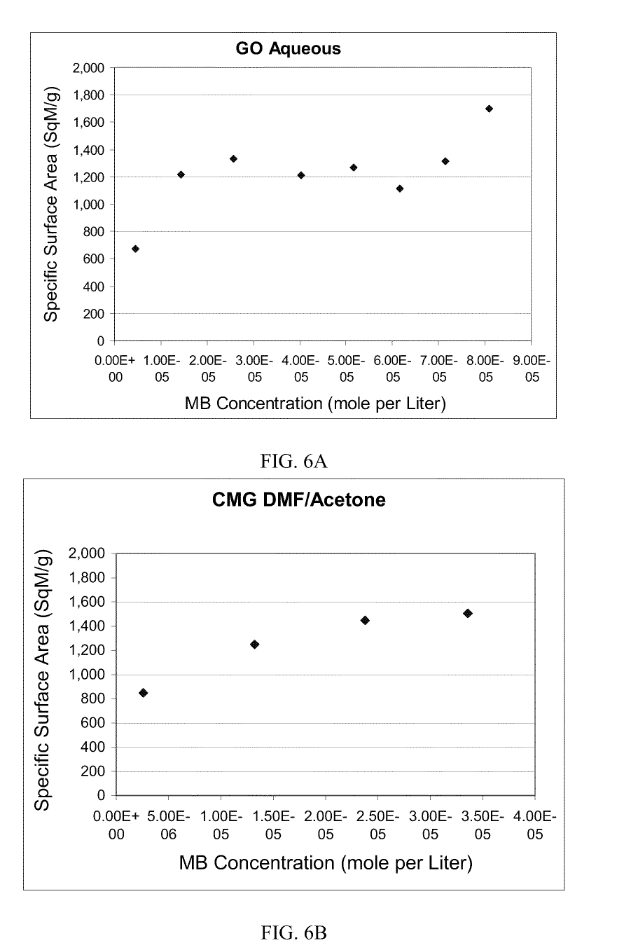

In a seventh example, the specific surface area of graphene oxide in aqueous suspension and reduced graphene oxide dispersed in a mixture of DMF/acetone were obtained using methylene blue (“MB”). The obtained specific surface area values (about 1,500 m²/g), in FIGS. 6A and 6B respectively, were approximately three times higher than those obtained with nitrogen BET methods on dried down samples. The methylene blue nitrogen surface area values are likely more representative of the actual surface area of a CMG material.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An electrochemical device comprising a chemically modified graphene material.

2. The electrochemical device of claim 1, wherein the device comprises a battery, a fuel cell, a capacitor, an ultracapacitor, or a combination thereof.

3. The electrochemical device of claim 1, wherein the device comprises an ultracapacitor.

4. The electrochemical device of claim 1, wherein the chemically modified graphene material is positioned in at least a portion of an electrode.

5. The electrochemical device of claim 4, wherein the electrode comprises at least one chemically modified graphene sheet.

6. The electrochemical device of claim 4, wherein the electrode comprises a plurality of chemically modified graphene sheets.

7. The electrochemical device of claim 1, wherein the chemically modified graphene material has a specific capacitance of at least about 100 F/g.

8. The electrochemical device of claim 1, wherein the chemically modified graphene material has a specific capacitance of at least about 500 F/g.

9. The electrochemical device of claim 1, wherein the chemically modified graphene material has an energy density of at least about 4 Wh/kg.

10. The electrochemical device of claim 1, having an energy density of at least about 25 Wh/kg.

11. The electrochemical device of claim 1, further comprising a paper-like material comprising stacked and/or overlapped CMG platelets.

12. The electrochemical device of claim 1, wherein the chemically modified graphene material is hydrophilic.

13. The electrochemical device of claim 1, wherein the chemically modified graphene comprises a plurality of individual graphene sheets, and wherein each individual graphene sheet is capable of moving with respect to any other graphene sheets.

14. The electrochemical device of claim 1, wherein at least a portion of the chemically modified graphene material is in a composite.

15. The electrochemical device of claim 14, wherein the composite comprises a polymer, a ceramic material, nanoparticles, or a combination thereof.

16. The electrochemical device of claim 1, wherein the chemically modified graphene material comprises one or more functional groups comprising a carboxyl, quinine, hydroxyl, carbonyl, anhydride, phenol, ether, lactone, nitrogen containing group, sulfur containing group, halide, halogen containing group, or a combination thereof.

17. The electrochemical device of claim 1, wherein the chemically modified graphene material is capable of being dispersed in an aqueous medium.

18. The electrochemical device of claim 1, wherein at least a portion of the chemically modified graphene material is prepared from a chemically modified exfoliated graphite oxide.

19. A method of making an electrochemical device, comprising forming an electrode comprising a chemically modified graphene material.

20. The method of claim 19, wherein the electrochemical device comprises an ultracapacitor, and wherein the method comprises:
a. forming two electrodes, wherein at least one of the two electrodes comprises a chemically modified graphene material, and
b. positioning each of the two electrodes such that each electrode is in contact with an opposing side of a separator and a current collector.
